(19) United States
(12) Patent Application Publication
(10) Pub. No.: US 2013/0229745 A1
(43) Pub. Date: Sep. 5, 2013

(54) Kung Fu Fan Taser Weapon

(71) Applicant: Robert Louis Unterlack, Wimauma, FL (US)

(72) Inventor: Robert Louis Unterlack, Wimauma, FL (US)

(21) Appl. No.: 13/600,257

(22) Filed: Oct. 25, 2012

Related U.S. Application Data
(60) Provisional application No. 61/606,823, filed on Mar. 5, 2012.

(51) Int. Cl. F41H 13/00; H05C 1/00

(52) U.S. Cl. CPC F41H 13/0018; H05C 1/00
USPC 361/232

(57) ABSTRACT

The Kung Fu Fan Taser is a weapon for Non-lethal personal self-defense purposes. It can be used by average men and women for personal security as a Taser device, a striking implement, and a Kung Fu Fan. When the fan is open in a locked position indicated by a snap on the blue button, the red button on the fan can be pressed to deliver an electrical shock. The electrical current that can strike and stun and individual fires along the fans perimeter edge when the fan is in a locked open position and the red button is pressed. The device can also have an optional Solar Panel Inlay in The Fans Fabric so the Fan can charge its own battery continuously via solar rays. Defensive possibilities increase for Martial Artists trained in the use of the Kung Fu Fans Classical Techniques.

This Kung Fu Taser Fan is a self-defense non-lethal weapon device for personal protection against street thugs and criminals. This Utility Invention is a modification of the Classical Chinese Kung Fu Fan.

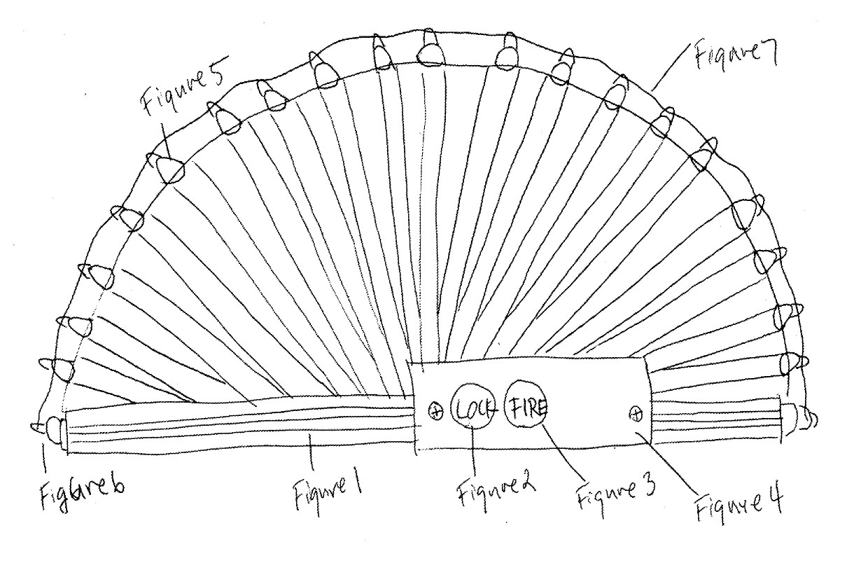

FIG. 1 shows wires extending out from a battery back along the base of the Fan. FIG. 4 shows the battery pack which is screwed onto the base of the fighting fan. FIGS. 2 and 3 shows two buttons that exist on the energy pack. In Figure two, when the fan is open all the way to its widest point, the fan snaps into place and the lock button, figure two, pops into place. FIG. 3 shows the fire button. Once the fan is open and locks into place, you are able to press the fire button to release the Taser charge. When the fire button, figure three, is pressed, the electricity fires out along the sheathed wires from the energy pack. The sheathed wires or FIG. 1, are connected to a metal coil around a ball bearing in FIG. 5. In FIG. 6, the metal barbed hook extends through a hole in the metal ball bearing and attaches to the sheathed wires along the fans base. The Ball Bearing, FIG. 5, receives the charge and transfers the charge to a coil copper wire that extends all the way around the fans perimeter in FIG. 7. The spring loaded coiled copper wire, FIG. 7, is laced along the fans perimeter inside a small barbed hook that is hooked through a small hole in the metal ball bearings center. When the fan is in the unlocked open position, the spring loaded coil copper wire helps the fan back into the closed position. The Charge is delivered in a chain like reaction along the coil copper wire across the entire perimeter of the fan when the fan is opened locked and the battery is charged and the fire is button pressed.

1. This invention has the ability to function as a normal Kung Fu Martial Arts fighting fan. But has the added features of being able to store and deliver an electrical Taser shock to a chosen target when the fan is open. The electrical charge is stored in a black battery mounted in the center of the fan. There are wires running up the length of the two outside fan blades or in other words the two perimeter fan blades that connect with the two ends of the copper conduction wire. The Kung Fu Fan Taser weapon also has the added ability to charge itself via solar rays from the sun because the fans fabric material is actually a solar panel. The fan is also an improvement on the previous kung fu martial arts fan because it has a spring wire across the top perimeter of the fan that helps retract the fan into a closed position and a blue lock button that prevents the coil from retracting the fan closed when it is in an open position. When the fan is in an open locked position, the user is able to press a red button next to the blue button and discharge an electrical charge to the target with the fan open. The fan is also able to close back into a stick like instrument when the blue locking button is pressed again and the fan is able to spring shut via the coil wire. The coil wire also serves to conduct the electrical shock along the fans perimeter when it is open. The wire is laced through a series of metal ball bearings at the tip of each of the fans blades, or at the head of each of the fans support blades. The solar panel is backed by a thin rubber matt that is on the reverse side of the fan also. The fan blades are made of a thick durable plastic and the fans handle is thickened with plastic to help with the grip and adds support to the weapon design during martial arts practice.
